(19) United States
(12) Patent Application Publication
(10) Pub. No.: US 2025/0150689 A1
(43) Pub. Date: May 8, 2025

(54) RECEIVING APPARATUS AND METADATA GENERATION SYSTEM

(71) Applicants: HISENSE VISUAL TECHNOLOGY CO., LTD., Qingdao (CN); TVS REGZA CORPORATION, Kawasaki (JP)

(72) Inventor: Makoto SHIBATA, Qingdao (CN)

(21) Appl. No.: 19/013,663

(22) Filed: Jan. 8, 2025

Related U.S. Application Data
(63) Continuation of application No. PCT/CN2023/101699, filed on Jun. 21, 2023.

(30) Foreign Application Priority Data
Jul. 8, 2022 (JP) 2022-110677

(51) Int. Cl. H04N 21/84; H04N 21/2187; H04N 21/234; H04N 21/81

(52) U.S. Cl. CPC H04N 21/84; H04N 21/2187; H04N 21/23424; H04N 21/812

(57) ABSTRACT

The present application relates to a receiving apparatus and a metadata generation system. Information of a broadcast program extracted according to each frame is effectively processed using limited system resources. The receiving apparatus is a receiving apparatus for receiving a broadcast program and providing same in a live broadcast viewing mode. The receiving apparatus comprises: a data processing unit that generates converted data according to a broadcast signal of the broadcast program when live broadcast viewing of the broadcast program is provided, wherein the converted data can be used for generating metadata representing the content of the broadcast program; and a first transceiver unit that transmits the converted data to a server apparatus that generates the metadata.

### CROSS-REFERENCES TO RELATED APPLICATIONS

The present disclosure is continuation application of PCT/CN2023/101699, filed on Jun. 21, 2023, which claims priority to the Japanese patent application No. 2022-110677 filed with the Japan Patent Office on Jul. 8, 2022, the entire content of all of which is incorporated herein by reference.

### TECHNICAL FIELD

Embodiments of the present application are directed to a receiving apparatus and a metadata generating system.

### BACKGROUND

In order to effectively watch various contents, the usability of metadata (Meta data) related to contents led by scenario information is attracting attention. In television broadcast programs, artificially generated metadata has so far been the mainstream, but in recent years, attempts have been made to use artificial intelligence (AI) to automatically generate metadata.

### PRIOR ART DOCUMENTS

### Patent Documents

Patent Document 1: Japanese Patent Application Publication No. 2006-108984
Patent Document 2: Japanese Patent Application Publication No. 2006-109126
Patent Document 3: Japanese Patent Application Publication No. 2011-008676

### SUMMARY

However, since the automatic generation of metadata requires huge processing, the problem is how to process information of a broadcast program extracted on a per-frame basis with limited system resources.

An object to be solved by the present disclosure is to provide a receiving apparatus and a metadata generation system that can efficiently process the information of the broadcast program extracted on a per-frame basis using limited system resources.

A receiving apparatus according to embodiments of the present application is a receiving apparatus that receives a broadcast program and provides the broadcast program which is available for being watched by a live broadcast. The receiving apparatus includes a data processing component, when providing a live broadcast of the broadcast program, configured to generate conversion data based on a broadcast signal of the broadcast program to enable generation of metadata representing a content of the broadcast program; and a first transceiver component, configured to transmit the conversion data to a server apparatus that generates the metadata.

### BRIEF DESCRIPTION OF FIGURES

FIG. 1 is a diagram showing an example of a structure of a metadata generation system according to the embodiments.

FIG. 2 is a block diagram showing an example of a hardware structure of a server apparatus according to the embodiments.

FIG. 3 is a block diagram showing an example of a functional structure of the server apparatus according to the embodiments.

FIG. 4 is a diagram showing an example of a hardware structure of a television apparatus according to the embodiments.

FIG. 5 is a block diagram showing an example of a functional structure of the television apparatus according to the embodiments.

FIG. 6 is a schematic diagram showing an example of the metadata generation system generating metadata according to the embodiments.

FIG. 7 is a schematic diagram showing an example of the metadata generation system determining an insertion position of an advertisement according to the embodiments.

FIG. 8 is a schematic diagram showing an example of task allocation in the television apparatus according to the embodiments.

FIG. 9 is a schematic diagram showing an example of allocating a pre-processing task of data conversion based on a remaining resource in the television apparatus according to the embodiments.

FIG. 10 is a schematic diagram showing an example of allocating a pre-processing task of data conversion based on a remaining resource in the television apparatus according to the embodiments.

FIG. 11 is a flowchart showing an example of a sequence of metadata generation processing in the metadata generation system according to the embodiments.

### EXPLANATION OF REFERENCE SIGNS

1 . . . metadata generation system, 10 . . . server apparatus, 11 . . . transceiver component, 12 . . . integration component, 13 . . . advertisement determination component, 14 . . . metadata generation component, 15 . . . storage component, 20 . . . television apparatus, 21 . . . transceiver component, 22 . . . task allocation component, 23 . . . data processing component, 24 . . . broadcast receiving component, 29 . . . storage component.

### DETAILED DESCRIPTION

### (Structure of Metadata Generation System)

FIG. 1 is a diagram showing an example of the structure of the metadata generation system 1 according to the embodiments. As shown in FIG. 1, the metadata generation system 1 includes a server apparatus 10 and a plurality of television apparatuses 20 (20a, 20b, 20c . . . 20n; where n is an arbitrary integer). The metadata generation system can generate metadata representing a content of a broadcast program through a cooperation of the server apparatus 10 and the television apparatus 20.

The server apparatus 10 is connected with the plurality of television apparatuses 20 wirelessly or wiredly through a network 30 such as the Internet. The network 30 may be, for example, a home network based on DLNA (Digital Living Network Alliance) (registered trademark), a home LAN (Local Area Network), or the like.

The television apparatus 20 as a receiving apparatus can, for example, receive broadcast signals from broadcasting stations and receive various broadcast programs. In addition, the television apparatus 20 may provide the user with the received broadcast program through live broadcast for watching, or may record and play the recorded broadcast program.

During providing the received broadcast program to the user, the television apparatus 20 can generate conversion data based on the broadcast signal of the broadcast program to enable generation of metadata including scenario information of the broadcast program and the like.

The server apparatus 10, for example, is configured as a cloud server placed on a cloud. The server apparatus 10 may also be configured as at least one computer which is provided with physical structures such as a CPU (Central Processing Unit), a ROM (Read Only Memory), and a RAM (Random Access Memory).

The server apparatus 10 receives the conversion data converted by each television apparatus 20 from these television apparatuses 20 and generates metadata. The server apparatus 10 provides the generated metadata to each television apparatus 20.

### (Structural Example of Server Apparatus)

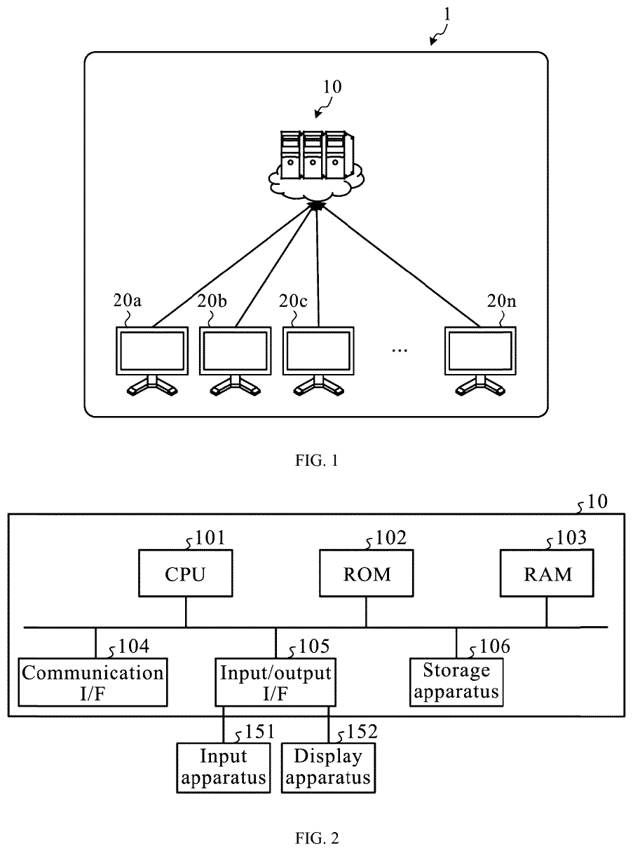

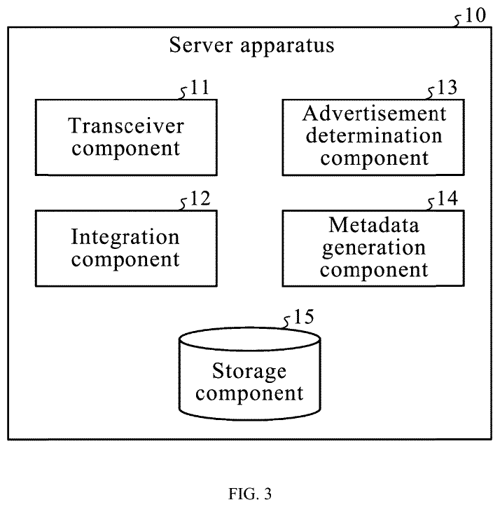

Next, a structural example of the server apparatus 10 according to the embodiments will be described using FIGS. 2 and 3.

FIG. 2 is a block diagram showing an example of a hardware structure of the server apparatus 10 according to the embodiments. As shown in FIG. 2, the server apparatus 10 includes a CPU 101, a ROM 102, a RAM 103, a communication I/F (interface) 104, an input/output I/F 105, an input apparatus 151, a display apparatus 152, and a storage apparatus 106.

The CPU 101 controls the entire server apparatus 10. The ROM 102 functions as a storage area in the server apparatus 10. Even if a power supply for the server apparatus 10 is cut off, information stored in the ROM 102 is maintained. The RAM 103 functions as a disposable storage apparatus and becomes a work area of the CPU 101.

For example, the CPU 101 expands a control program and the like stored in the ROM 102 into the RAM 103 and executes it, thereby obtaining the function of the server apparatus 10 that generates the metadata based on the conversion data collected from the plurality of television apparatuses 20.

In addition, the control program described above can be recorded on various computer-readable storage media such as a floppy disk, CD-R, DVD (Digital Versatile Disk), Blu-ray Disc (registered trademark), semiconductor memory, etc. and provided.

In addition, the control program may be stored in a computer connected with a network such as the Internet, and may be provided by downloading from the network. In addition, the control program may be provided or distributed through a network such as the Internet.

The communication I/F 104, for example, can be connected with a network 30 such as the Internet. Through the communication I/F 104, various information can be transmitted and received between the server apparatus 10 and the plurality of television apparatuses 20.

The input/output I/F 105 can also be connected with the input apparatus 151 such as a keyboard or a mouse, etc., and be connected with the display apparatus 152 such as a monitor, etc. As a result, for example, the administrator, etc., of the server apparatus 10 can perform various operations on the server apparatus 10.

The storage apparatus 106 is an HDD (Hard Disk Drive), an SSD (Solid State Drive), or the like, and functions as an auxiliary storage apparatus for the CPU 101.

FIG. 3 is a block diagram showing an example of a functional structure of the server apparatus 10 according to the embodiments. As shown in FIG. 3, the server apparatus 10 includes a transceiver component 11, an integration component 12, an advertisement determination component 13, a metadata generation component 14, and a storage component 15.

The above-mentioned functional structure of the server apparatus 10 can be realized, for example, by the CPU 101 that executes the control program or the hardware structure of each component of the server apparatus 10 as shown in FIG. 2 that operates under the control of the CPU 101.

The transceiver component 11 as a second transceiver component can transmit and receive data between the plurality of television apparatuses 20 and the server apparatus 10. The transceiver component 11 receives, for example, the conversion data generated by the television apparatuses 20 based on broadcast signals of broadcast programs from the plurality of television apparatuses 20. Furthermore, the transceiver component 11 transmits the metadata generated by the server apparatus 10 to the plurality of television apparatuses 20.

The integration component 12 integrates the conversion data generated by the plurality of television apparatuses 20 for each frame into time sequence data arranged in time sequence. In this case, the integration component 12 selects from the conversion data collected from the plurality of television apparatuses 20 so as to obtain time sequence data for all broadcast programs being broadcast by the plurality of broadcasting stations in a predetermined period.

For example, if a user of a certain television apparatus 20 consistently watches a broadcast program of a broadcasting station, the integration component 12 may generate time sequence data of one broadcast program using only the conversion data collected from this television apparatus 20.

Alternatively, when a user of a certain television apparatus 20 repeatedly selects channels and watches multiple broadcast programs, time sequence data of one broadcast program can also be generated using conversion data collected from multiple television apparatuses 20 in this situation.

The advertisement determination component 13 determines the insertion position of the advertisement based on the time sequence data. The conversion data from the television apparatus 20 contains information inferred by the television apparatus 20 regarding the insertion location of the advertisement. The advertisement determination component 13 refers to the inference information inferred by the television apparatus 20 to determine the insertion position of the advertisement.

The metadata generation component 14 generates metadata, such as scenario information, Etc., representing the content of the broadcast program based on conversion data other than the insertion position of the advertisement, that is, conversion data generated from the main part of the broadcast program.

The storage component 15 stores various parameters, control programs, and the like required for the operation of the server apparatus 10. In addition, the storage component 15 may also store the conversion data collected from the plurality of television apparatuses 20, the time sequence data generated from the conversion data, information about determined insertion positions of the advertisement, the metadata generated based on the conversion data, and the like.

### (Structural Example of Television Apparatus)

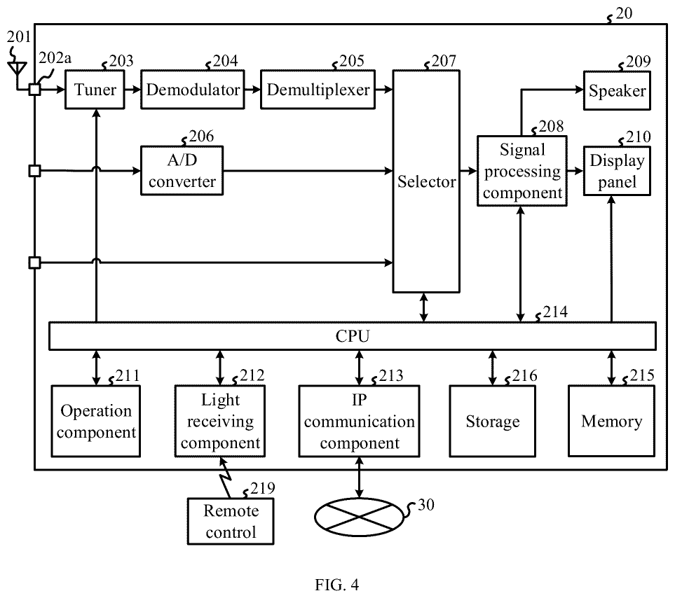

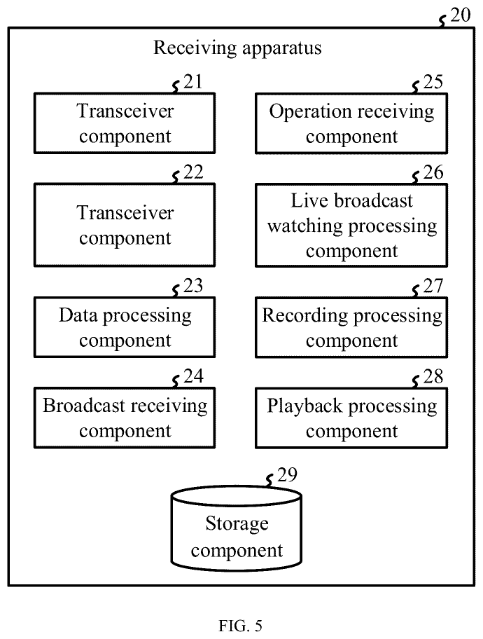

Next, a structural example of the television apparatus 20 according to the embodiments will be described using FIGS. 4 and 5.

FIG. 4 is a diagram showing an example of a hardware structure of the television apparatus 20 according to the embodiments.

As shown in FIG. 4, the television apparatus 20 includes an antenna 201, input terminals 202a to 202c, a tuner 203, a demodulator 204, a demultiplexer 205, an A/D (analog/digital) converter 206, a selector 207, a signal processing component 208, a speaker 209, a display panel 210, an operation component 211, a light receiving component 212, an IP communication component 213, a CPU 214, a memory 215, and a storage 216.

The antenna 201 receives a broadcast signal(s) of digital broadcast(s) and supplies the received broadcast signal(s) to the tuner 203 via the input terminal 202a.

The tuner 203 selects a broadcast signal of a desired channel from the broadcast signals supplied from the antenna 201, and supplies the selected broadcast signal to the demodulator 204.

The demodulator 204 demodulates the broadcast signal supplied from the tuner 203, and supplies the demodulated broadcast signal to the demultiplexer 205.

The demultiplexer 205 separates the broadcast signal supplied from the demodulator 204 to generate a video signal and an audio signal, and supplies the generated video signal and audio signal to the selector 207.

The selector 207 selects one from the plurality of signals supplied from the demultiplexer 205, the A/D converter 206, and the input terminal 202c, and supplies the selected signal to the signal processing component 208.

The signal processing component 208 performs predetermined signal processing on the video signal supplied from the selector 207 and supplies the processed video signal to the display panel 210. Furthermore, the signal processing component 208 performs predetermined signal processing on the audio signal supplied from the selector 207 and supplies the processed audio signal to the speaker 209.

The speaker 209 outputs voice or various sounds based on the audio signal supplied from the signal processing component 208. In addition, the speaker 209 changes the volume of the output voice or various sounds based on the control of the CPU 214.

The display panel 210 displays videos such as still images and dynamic images, other images, text information, and the like based on the video signal supplied from the signal processing component 208 or the control of the CPU 214.

The input terminal 202b receives analog signals such as video signals and audio signals input from the outside. In addition, the input terminal 202c receives digital signals such as video signals and audio signals input from the outside. For example, the input terminal 202c can be input into a digital signal from a recorder equipped with a driver apparatus that drives a storage medium, such as BD (Blu-ray Disc) (registered trademark) and the like, for recording and playback to perform recording and playback.

The A/D converter 206 supplies a digital signal to the selector 207, and the digital signal is generated by performing A/D conversion on the analog signal supplied from the input terminal 202b.

The operation component 211 receives an operation input from the user.

The light receiving component 212 receives infrared rays from a remote control 219.

The IP communication component 213 is a communication interface for performing IP (Internet Protocol) communication via the network 30. The television apparatus 20 may be connected with a network other than the Internet such as LAN, and may be connected with the above-mentioned server apparatus 10 in such a way that various information can be transmitted and received via such a network.

The CPU 214 controls the entire television apparatus 20.

The memory 215 is a ROM that stores various computer programs executed by the CPU 214, a RAM that provides work areas for the CPU 214, and the like. For example, the ROM stores control programs and application programs for realizing various functions of the television apparatus 20.

The memory 216 is an HDD (Hard Disk Drive), an SSD (Solid State Drive), or the like. The memory 216, for example, stores the signal selected by the selector 207 as recording data.

FIG. 5 is a block diagram showing an example of a functional structure of the television apparatus 20 according to the embodiments. As shown in FIG. 5, the television apparatus 20 includes a transceiver component 21, a task allocation component 22, a data processing component 23, a broadcast receiving component 24, an operation receiving component 25, a live broadcast watching processing component 26, a recording processing component 27, a playback processing component 28, and a storage component 29.

The above-mentioned functional structure of the television apparatus 20 can be realized by, for example, the CPU 214 executing the control program or the hardware structure of each component of the television apparatus 20 shown in FIG. 4 operating under the control of the CPU 214.

The broadcast receiving component 24 receives a broadcast signal of a broadcast program transmitted from a broadcasting station. The broadcast signal includes video information and audio information, and program arrangement information (SI: Service Information) representing the content of the broadcast program is multiplexed in consideration of convenience in program selection. An example of the program arrangement information is information related to an electronic program guide (EPG) including information on a TV column corresponding to news.

The above-mentioned video information, audio information, and the transmission control information attached thereto constitute a transport stream (TS) that is compressed into the MPEG 2 format and is multiplexed.

The broadcast receiving component 24 can receive the video information, the audio information, the program arrangement information, etc., that are multiplexed, in the broadcast signal.

The operation receiving component 25 receives various operations from the user, such as live broadcast watching operations, recording operations, recording reservation operations, and playback operations, etc.

The live broadcast watching processing component 26 performs a live broadcast watching processing of the broadcast program. The live broadcast for watching means, for example, real-time display of a broadcast program being broadcast at that time.

The recording processing component 27 executes the processing for the recording of the broadcast program based on the recording operation and the recording reservation operation from the user. The recording processing component 27 stores the recorded program in the storage component 29.

Based on the playback operation from the user, the playback processing component 28 reads the recorded program from the storage component 29 and performs playback processing.

For example, the data processing component 23 converts a broadcast signal of a broadcast program that the television apparatus 20 is currently providing for real-time watching into a format from which the above-mentioned server apparatus 10 can generate the metadata. More specifically, the data processing component 23 converts the data of the broadcast signal of the broadcast program being provided for watching by live broadcast into a multi-dimensional array for each frame, and further generates conversion data containing an estimation result for the content of the broadcast program estimated from the multi-dimensional array.

As the estimation result for the program content, there are, for example, an inference start position and an inference end position of an advertisement for distinguishing the main part from an advertisement, information identifying a performer in the broadcast program, and the like.

When the data processing component 23 performs data conversion processing, the task allocation component 22 allocates tasks representing contents of the processing. When the data processing component 23 performs data conversion processing, tasks required for data conversion may differ depending on the contents of the broadcast programs or frames. The task allocation component 22 refers to, for example, program arrangement information included in the broadcast signal, to appropriately determine the required tasks, and allocates them to the data processing component 23.

The transceiver component 21 as the first transceiver component can transmit and receive data between the television apparatus 20 and the server apparatus 10. The transceiver component 21 transmits the conversion data generated by the television apparatus 20 based on the broadcast signal of the broadcast program to the server apparatus 10. In addition, the transceiver component 21 receives the metadata generated by the server apparatus 10.

The storage component 29 stores various parameters, control programs, and the like required for the operation of the television apparatus 20. In addition, the storage component 29 may store recorded programs, the conversion data generated by the data processing component 23, the metadata received from the server apparatus 10, and the like.

In addition, regarding the case where the resources of the television apparatus 20 are used in the generation process of metadata in the server apparatus 10, it is set that the user of the television apparatus 20 accepts permission.

### (Example of Metadata Generation)

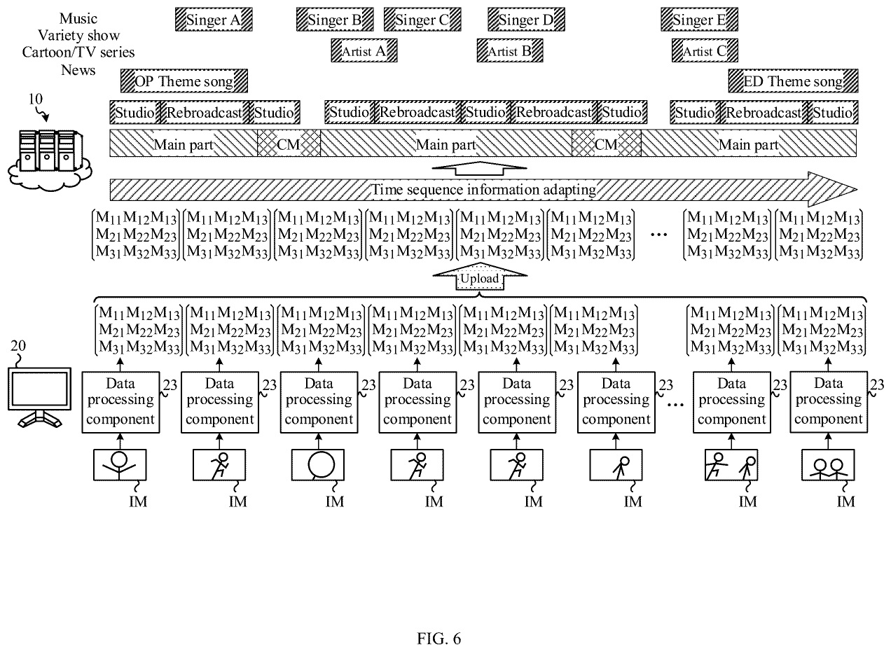

Next, an example of metadata generation by the server apparatus 10 and the television apparatus 20 according to the embodiments will be described using FIG. 6.

FIG. 6 is a schematic diagram showing an example of the metadata generation system 1 generating metadata according to the embodiments. It should be noted that in FIG. 6, time is set to pass from left to right on the paper.

As shown in FIG. 6, for a broadcast program that is provided for watching via the live broadcast by the television apparatus 20, the data processing component 23 captures the watching picture of each frame, and obtains a multi-dimensional array from the captured watching picture IM. More specifically, the data processing component 23 converts the transport stream of the broadcast program into a multi-dimensional array based on floating point values or integer values. A multi-dimensional array is a multi-column array that uses the concept of a matrix to store multiple variables.

Large amounts of data can be processed by using a multi-dimensional array. For example, taking the watching picture IM captured by the data processing component 23 as an example, a specific example will be given below. As for the original watching picture IM, assuming that the task allocation component 22 selects the start inference position and the end inference position of the advertisement as tasks, in the case of terrestrial digital broadcasting, it has a pixel number of (3×1440×1080) pixels. By converting this into a multi-dimensional array, as an example, the output can be set to (1×576) pixels or (1×5) pixels. However, these specific numerical values related to input and output are just an example. In any case, by using the multi-dimensional array, the number of array elements of the original watching picture IM can be greatly reduced.

Therefore, by using the multi-dimensional array as input and output data to a deep neural network (DNN) or the like, image recognition, and voice recognition, etc., based on the DNN become easier. In addition, as will be described later, by converting into the multi-dimensional array, the capacity of the data to be processed in the server apparatus 10 can be reduced, and more content information can be collected and processed.

The data processing component 23 generates the conversion data including the estimation result using, for example, the DNN technology described above, the estimation result is a result of estimating a difference between the main part of the broadcast program and the advertisement, performers in the broadcast program, and other scenario information.

The transceiver component 21 of the television apparatus 20 transmits the generated conversion data of each frame to the server apparatus 10 through the network 30 together with the program arrangement information multiplexed in the received broadcast signal. The conversion data is uploaded from the television apparatus 20 to the server apparatus 10 periodically, for example, every 5 minutes.

The integration component 12 of the server apparatus 10 selects from the conversion data of each frame collected from the plurality of television apparatuses 20, and, for example, generates time sequence data for all the plurality of broadcast programs broadcast simultaneously. The generation processing of the time sequence data is also performed periodically, for example, every 5 minutes, in accordance with the moments of data upload from the plurality of television apparatuses 20.

As described above, the advertisement determination component 13 determines the insertion position of the advertisement based on the time sequence data. Furthermore, the metadata generation component 14 refers to the program arrangement information added to the conversion data to generate the metadata representing the program content for the main part of the broadcast program.

The metadata generated by the metadata generation component 14 includes, for example, metadata representing the difference between the main part of the broadcast program and the advertisement.

For example, the metadata generation component 14 generates, in association with the moments corresponding to the time sequence data: metadata representing the advertisement part in association with the time sequence data corresponding to the insertion position of the advertisement determined by the advertisement determination component 13; or metadata representing the metadata of the main part in association with the time sequence data corresponding to the part other than the insertion position of the advertisement.

Alternatively, based on the program arrangement information, the metadata generation component 14 may omit the above-mentioned processing when there is no broadcast program with advertisements like NHK.

In addition, for example, when the broadcast program for which the metadata is generated is a music program, the metadata generation component 14 refers to the program arrangement information to determine, for example, the respective singing moments of singer A, singer B, singer C, etc., and to generate metadata including these singer names and the like in association with moments corresponding to the time sequence data.

In addition, for example, when the broadcast program for which the metadata is generated is a joint performance, the metadata generation component 14 refers to the program arrangement information to determine, for example, performance moments of artist A, artist B, artist C, etc., and to generate metadata including these artist names and the like in association with moments corresponding to the time sequence data.

In addition, for example, when the broadcast program for which the metadata is generated is a cartoon or a TV series, the metadata generation component 14 refers to the program arrangement information to determine, for example, a broadcast moment of the opening or ending theme song and to generate metadata representing the part of the theme song in association with moments corresponding to the time sequence data.

In addition, for example, when the broadcast program for which the metadata is generated is a news program, the metadata generation component 14 refers to the program arrangement information to determine, for example, a broadcast moment from the studio, a moment of input rebroadcast and the like, and to generate metadata representing the broadcast part from the studio or metadata representing the relay part in association with moments corresponding to the time sequence data.

The transceiver component 11 of the server apparatus 10 transmits the metadata generated as described above to the plurality of television apparatuses 20. At this time, the metadata may be distributed to all the television apparatuses 20 connected with the server apparatus 10, or may be transmitted to the television apparatus 20 in which the request exists among the plurality of television apparatuses 20.

In each television apparatus 20, when playing a recorded program, etc., corresponding metadata is displayed based on the user's operation. Thereby, the user can refer to the metadata to effectively watch the recorded program.

In addition, the playback of the recorded program includes not only playing the recorded program at any time after the program ends, but also including playing the recorded content retroactively during watching the live broadcast without waiting for the end of the recording while the program is being broadcast. This playback method is also called time shift playback, etc.

### (Example of Determining Advertisement Insertion Position)

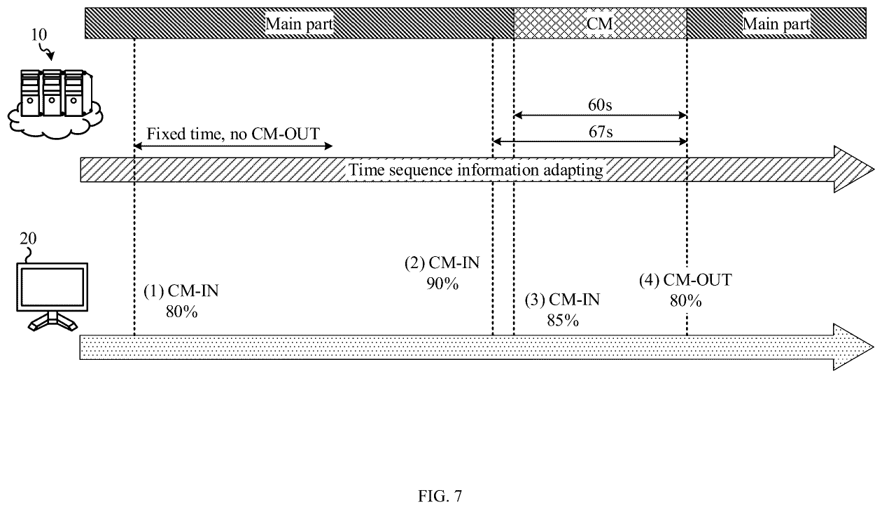

Next, an example of determining the insertion position of the advertisement in the metadata generation system 1 will be described using FIG. 7.

FIG. 7 is a schematic diagram showing an example of the metadata generation system 1 determining an insertion position of an advertisement according to the embodiments. It should be noted that in FIG. 7, time is set to pass from left to right on the paper.

As shown in FIG. 7, the data processing component 23 of the television apparatus 20 adds information of the inference start position and the inference end position of the advertisement using, for example, DNN technology, based on the multi-dimensional array in which data based on the broadcast signal of the broadcast program is converted. . . . The information of the inference start position and the inference end position may also include the accuracy of these inferences.

In the server apparatus 10 that has received the conversion data including this information, the advertisement determination component 13 determines the insertion position of the advertisement in the time sequence data.

In the example of FIG. 7, for example, information of the inference start position of the advertisement (accuracy: 80%) ((1) in FIG. 7) is included at the beginning of the time sequence data. However, the time sequence data does not include information of the inference end position of the advertisement beyond the predetermined period. In this case, the advertisement determination component 13 determines that the estimation result of the inference start position of the advertisement at the beginning of the time sequence data is wrong, and the advertisement is not started at that time.

In addition, the broadcast time of advertisements is often standardized to a maximum of 1 minute in units of 15 seconds. Therefore, the predetermined period used by the advertisement determination component 13 for determination may be set to, for example, 1 minute.

In addition, in the example of FIG. 7, the subsequent time sequence data includes information of the inference start positions of two advertisements (accuracy: 90%, accuracy: 85%) ((2) and (3) of FIG. 7). In contrast, there is only one piece of information of the inference end position of the advertisement that is considered to correspond to the inference start positions (accuracy: 80%) ((4) in FIG. 7). In this case, the advertisement determination component 13 adopts, from combinations of the two inference start positions each with one inference end position, a combination whose advertisement insertion time is approximate to a multiple of the shortest broadcast period of the advertisement.

That is, as mentioned above, the broadcast time of the advertisement is standardized to increase in units of 15 seconds. In the example of FIG. 7, if the earlier inference start position ((2) in FIG. 7) of the two inference start positions and the inference end position following it are combined, the insertion time of the advertisement becomes 67 seconds. On the other hand, if the later inference start position ((3) in FIG. 7) of the two inference start positions and the inference end position following it are combined, the insertion time of the advertisement becomes 60 seconds.

As mentioned above, in the combination of the later inference start position and the inference end position following it, the broadcast time of the advertisement is more approximate to a multiple of 15 seconds. Therefore, the advertisement determination component 13 adopts the later inference start position among the two inference start positions as the start position of the advertisement.

In addition, in this example, the position with the lower accuracy among the two inference start positions is finally used. However, the advertisement determination component 13 may also add the level of accuracy to the determination criterion in addition to determining whether it is approximate to the multiple of the shortest broadcast period of the advertisement.

### (Example of Task Allocation)

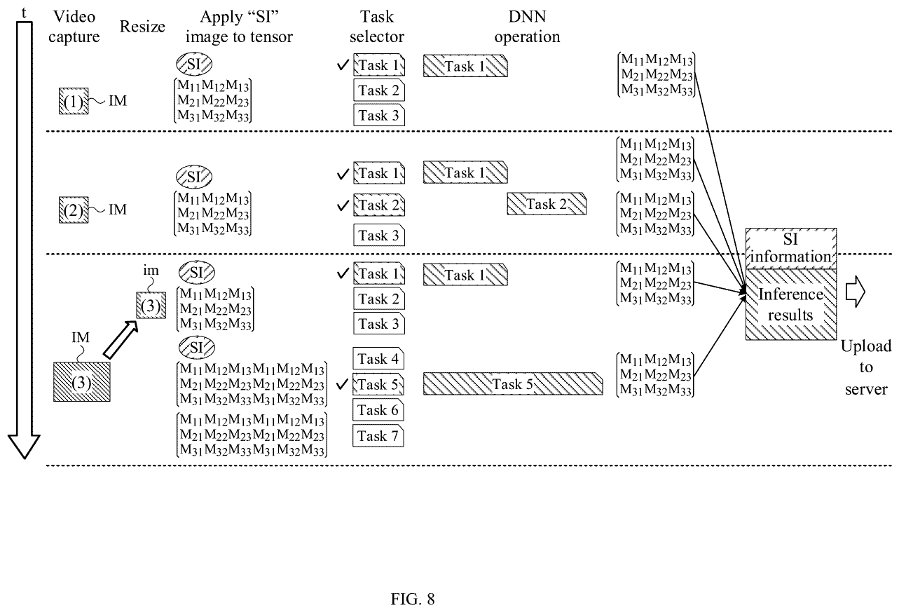

Next, an example of task allocation in the television apparatus 20 according to the embodiments will be described using FIG. 8.

FIG. 8 is a schematic diagram showing an example of task allocation in the television apparatus 20 according to the embodiments. It should be noted that in FIG. 8, time is set to pass from the upper part to the lower part of the paper.

As described above, when the data processing component 23 performs data conversion on a predetermined broadcast program, the tasks required for data conversion may differ for content or each frame of the broadcast program.

For example, in song programs or TV dramas, as mentioned above, facial authentication of performing singers and performers may be performed to determine the performance moment of each performer sometimes. On the other hand, if it is a news program or the like, such processing is usually not required.

In addition, for example, in the case of a private broadcast program, processing may be performed to determine the inference start position and the inference end position of the advertisement sometimes. On the other hand, if it is an NHK broadcast program, such processing is not required.

In addition, for example, in the case of high-definition broadcasting, processing may be performed to resize the capacity of the captured watching picture sometimes.

In the example of FIG. 8, tasks 1 to 7 represent tasks that may differ depending on the contents or respective frames of the broadcast program. In addition, among these tasks 1 to 7, the processing of tasks 1 to 3 is tasks that can be executed with relatively few resources. On the other hand, among these tasks 1 to 7, the processing of tasks 4 to 7 is tasks that require a relatively large amount of resources.

For example, it is assumed that the data processing component 23 is capturing a predetermined watching picture IM ((1) in FIG. 8) in the moment of the uppermost segment of FIG. 8. The task allocation component 22 refers to the program arrangement information at that moment to determine the task(s) required for generating conversion data based on the watching picture IM captured by the data processing component 23. More specifically, the task allocation component 22 selects, for example, the task 1 from a plurality of candidates for tasks 1 to 3 and allocates it to the data processing component 23.

As described above, the processing of tasks 1 to 3 including task 1 can be executed with relatively few resources. In this case, the task allocation component 22 determines that there is remaining resource in the data processing component 23.

In addition, for example, in the moment of the middle segment of FIG. 8, it is assumed that the data processing component 23 is capturing another watching picture IM ((2) in FIG. 8). The task allocation component 22 refers to the program arrangement information at that moment to determine the task(s) required for generating conversion data based on the watching picture IM captured by the data processing component 23. In the example of FIG. 8, the task allocation component 22 selects, for example, the tasks 1 and 2 from a plurality of candidates for tasks 1 to 3 and allocates them to the data processing component 23.

At this time, although the processing of task 1, task 2, and task 3 can be executed one by one using relatively few resources, the data processing component 23 has two processings of task 1 and task 2. In this case, the task allocation component 22 determines that the data processing component 23 has no remaining resource and cannot process other tasks.

In addition, for example, it is assumed that the data processing component 23 further captures another watching picture IM ((3) in FIG. 8) in the moment of the lowest segment of FIG. 8. The task allocation component 22 refers to the program arrangement information at that moment to determine the task(s) required for generating conversion data based on the watching picture IM captured by the data processing component 23.

In the example of FIG. 8, the task allocation component 22 selects, for example, the task 1 from a plurality of candidates for tasks 1 to 3 and allocates it to the data processing component 23. In addition, the task allocation component 22 selects, for example, the task 5 from a plurality of candidates for tasks 4 to 7 and allocates it to the data processing component 23.

At this time, among the tasks 1 and 5 allocated to the data processing component 23, the task 5 is a processing of resizing the watching picture IM to the watching picture im. Such processing requires relatively more resources.

In this case, the task allocation component 22 also determines that the data processing component 23 has no remaining resource and cannot process other tasks.

In addition, the conversion data of each frame including the estimation results through these tasks is uploaded to the server apparatus 10.

### (Usage Example of Remaining Resource)

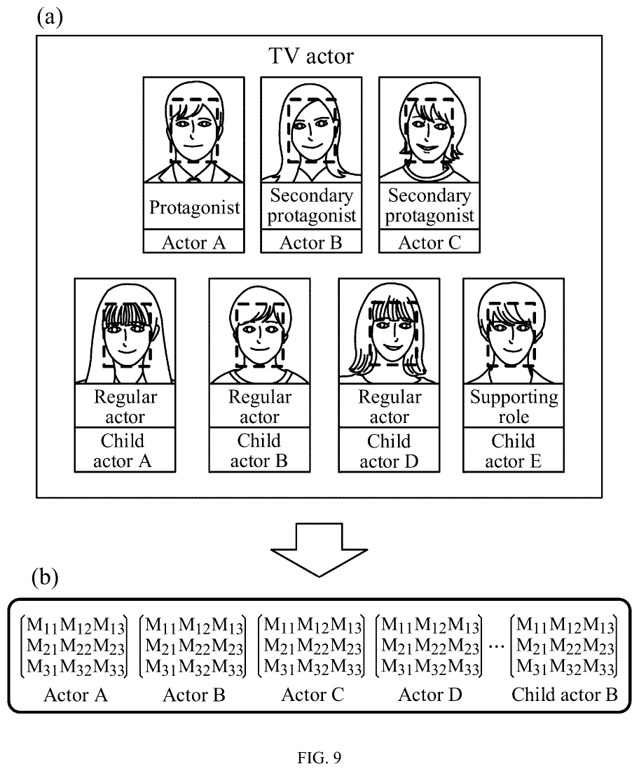

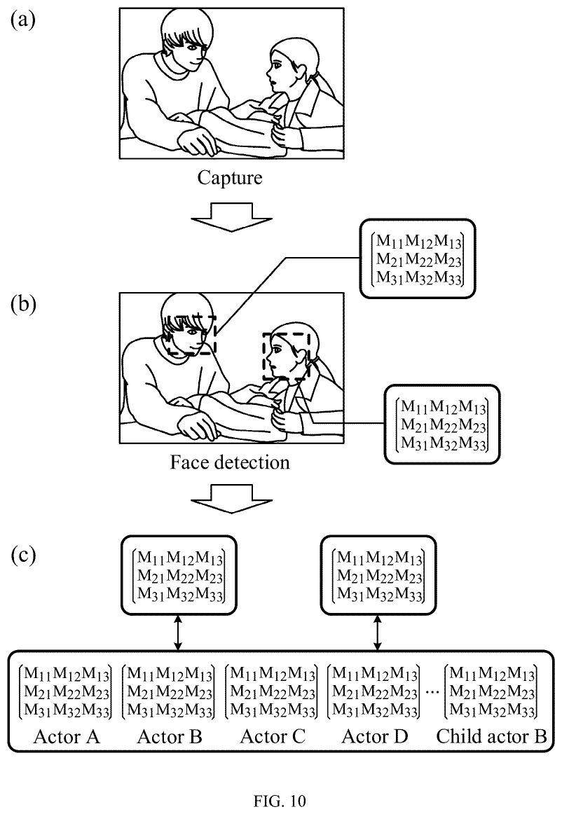

Next, a usage example of the remaining resource in the television apparatus 20 according to the embodiment will be described using FIGS. 9 and 10.

FIGS. 9 and 10 are schematic diagrams showing an example of allocating tasks of pre-processing of data conversion based on the remaining resource to in the television apparatus 20 according to the embodiments. In the examples of FIGS. 9 and 10, as a pre-processing of data conversion, a processing of pre-extracting feature amounts of performers of a predetermined TV drama is performed.

As shown in FIG. 6, for example, when analyzing a broadcast program such as a variety show or a TV drama, the data processing component 23 of the television apparatus 20 may perform processing such as detecting the performance moment of a predetermined performer in these broadcast programs. At this time, for example, face authentication using DNN technology is performed to identify each performer and the moments when these performers appear on the watching picture are determined.

Therefore, for example, by pre-extracting facial feature amounts of a predetermined performer, facial authentication of each performer can be quickly performed based on the extracted feature amounts during the data conversion processing.

As shown in (a) of FIG. 9, when the remaining resource is generated in the data processing component 23 at a predetermined moment, the task allocation component 22 of the television apparatus 20, for example, allocates a task of extracting the facial feature amounts of the performer of the predetermined TV drama to the data processing component 23. Facial photographs and the like of each performer used for extracting facial feature amounts may be stored in, for example, the server apparatus 10.

In this case, the administrator of the server apparatus 10 or the like may pre-store facial photograph data that has obtained a usage permission of the performer of the TV drama in the storage component 15 of the server apparatus 10. Alternatively, the television apparatus 20 may autonomously acquire facial photographs of performers included in the program arrangement information and the like and store them in the storage component 29. In this case, full permission may be pre-obtained regarding the use of the program arrangement information in the metadata generation system 1 including the television apparatus 20.

As shown in (b) of FIG. 9, the data processing component 23 of the television apparatus 20 extracts the facial feature amount of each performer from the provided facial photograph of the performer and stores it in, for example, the storage component 29. Then, when conversion data is generated for the TV series performed by these performers, each performer can be identified with reference to the feature amounts stored in the storage component 29. Its status is shown in FIG. 10.

As shown in (a) of FIG. 10, for a TV drama in which facial feature amounts of performers have been extracted, the data processing component 23 converts the information included in the watching picture captured for each frame into a multi-dimensional array.

As shown in (b) of FIG. 10, the data processing component 23 performs analysis based on the generated multi-dimensional array and extracts the facial feature amount of the performer included in the watching picture.

As shown in (c) of FIG. 10, the data processing component 23 reads data of the facial feature amount of each performer stored in the storage component 29 and compares it with the facial feature amount of the performer included in the watching picture to determine the performer included in the watching picture.

In addition, the television apparatus 20 may transmit the generated facial feature amount of the performer to the server apparatus 10. In addition, the server apparatus 10 may distribute the feature amounts generated by the predetermined television apparatus 20 to other television apparatuses 20, and when each television apparatus 20 performs data conversion, the feature amounts generated by one television apparatus 20 may be shared among these television apparatuses 20.

### (Example of Metadata Generation Processing)

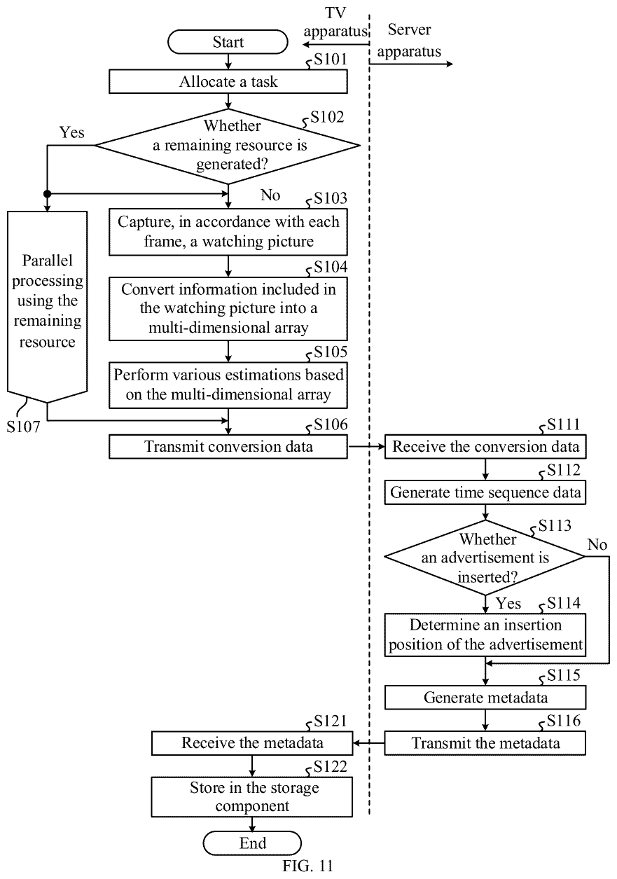

Next, an example of metadata generation processing performed by the metadata generation system 1 according to the embodiments will be described using FIG. 11. FIG. 11 is a flowchart showing an example of a sequence of metadata generation processing performed by the metadata generation system 1 according to the embodiments.

As shown in FIG. 11, when starting watching a predetermined broadcast program, the task allocation component 22 of the television apparatus 20 allocates a task to the data processing component 23 (step S101).

In other words, the task allocation component 22 determines the task required for data conversion based on the content or each frame of the broadcast program while referring to the program arrangement information. In addition, the task allocation component 22 allocates the determined task to the data processing component 23.

Furthermore, the task allocation component 22 determines whether there is any remaining resource generated in the data processing component 23 based on the determined task (step S102).

When it is determined that no remaining resource is generated (step S102: No), the data processing component 23 executes the processing of steps S103 to S105 based on the allocated task. When it is determined that the remaining resource is generated (step S102: Yes), the data processing component 23 further allocates the task corresponding to the remaining resource to the data processing component 23 (step S107).

Specifically, the data processing component 23 captures, in accordance with each frame, a watching picture of the broadcast program for which watching has begun (step S103). Furthermore, the data processing component 23 converts information included in the watching picture into a multi-dimensional array (step S104). In addition, the data processing component 23 performs various estimations based on the multi-dimensional array and generates estimation results (step S105).

In addition, when the task corresponding to the remaining resource is further allocated, the data processing component 23 simultaneously performs the processing of steps S103 to S105 and executes processing based on the allocated task (step S107).

The transceiver component 21 transmits conversion data generated as described above to the server apparatus 10 (step S106). The transceiver component 11 of the server apparatus 10 receives the conversion data from the television apparatus 20 (step S111).

The integration component 12 selects from the conversion data collected from the plurality of television apparatuses 20, respectively integrates the plurality pieces of conversion data related to the respective broadcast programs, and generates time sequence data corresponding to each of these broadcast programs (step S112).

For example, the advertisement determination component 13 refers to the program arrangement information corresponding to the generated time sequence data to determine whether an advertisement is inserted of in the time sequence data (step S113).

In other words, the advertisement determination component 13, based on the program arrangement information, determines that no advertisement is inserted when the broadcast program corresponding to the time sequence data is an NHK broadcast program, and determines that the advertisement is inserted when the broadcast program is a private broadcast program. However, the advertisement determination component 13 may perform the above determination based on whether the data processing component 23 of the television apparatus 20 assigns the inference start position and the inference end position of the advertisement to the time sequence data instead of the program arrangement information, or on the basis of the program arrangement information.

When it is determined that the advertisement is inserted in the time sequence data (step S113: Yes), the advertisement determination component 13 determines an insertion position of the advertisement based on the inference start position and the inference end position of the advertisement assigned in the time sequence data (step S114). When it is determined that no advertisement is inserted in the time sequence data (step S113: No), the advertisement determination component 13 skips the process of step S114.

The metadata generation component 14 generates metadata representing the content of the broadcast program based on the time sequence data and the estimation result of the data processing component 23 assigned to the time sequence data for the main part excluding the insertion position of the advertisement in the time sequence data (step S115).

The transceiver component 11 transmits the metadata generated as described above to the television apparatus 20 (step S116). The transceiver component 21 of the television apparatus 20 receives the metadata from the server apparatus 10 (step S121), and stores the metadata in the storage component 29 for display when watching a recorded program, for example (step S122).

As described above, the metadata generation process performed by the metadata generation system 1 of the embodiments is completed.

### Comparative Example

With the increase in content in recent years, it has become important to provide a search function for the content and a recommendation function for each content, as well as an effective watching method. In order to realize effective watching of content, metadata including scenario information is useful.

Until now, the metadata of TV broadcast programs has been mainly produced manually. In addition to the hours required from the end of broadcast to production, the production cost of metadata has also become huge. So start trying to use artificial intelligence to automatically generate metadata. However, automatic generation of metadata, for example, has the following problems.

Television apparatuses require real-time processing for watching, recording and playback. Therefore, it is difficult for a television apparatus to automatically generate metadata that requires processing for time sequence data.

Furthermore, system resources are limited in television apparatuses. Therefore, it is difficult to cause the television apparatus to perform complex processing using artificial intelligence and simultaneous parallel processing. Therefore, for this reason, it is difficult for a television apparatus to automatically generate metadata.

On the other hand, when the server apparatus automatically generates metadata, the cost on the server apparatus side becomes huge in order to process a large amount of content in the server apparatus.

For example, in the technology of the above-mentioned Patent Documents 1 and 2, a logo image, a pattern file, etc., are prepared and distributed in the cloud in advance, so that the television apparatus detects the advertising interval. However, it is necessary to purchase a logo video or the like from an advertisement provider, which requires huge costs to expand the target content. In addition, since the television apparatus is required to detect the advertising interval, there is a concern about processing delays.

Furthermore, in the technology of the above-mentioned Patent Document 3, a terminal apparatus in the medical field generates feature amounts using artificial intelligence in real time, and uses the feature amounts to execute processing using the time sequence data. However, it is difficult to apply such technology to television broadcast programs.

For television broadcast programs, for example, there is a time-shift playback function that requires to play the recorded content during the live broadcast for watching, and a function that collectively records all broadcast programs on all channels. In order to meet these requirements, multiple AV (Audio/Visual) decoders and AI operators for real-time parallel processing of multiple contents need to be installed in the television apparatus. Since such a structure is a big obstacle in terms of both component cost and running cost, it is unrealistic to apply it to the television apparatus as a consumer apparatus.

According to the television apparatus 20 of the embodiments, while providing a live broadcast of a broadcast program for watching, the conversion data is generated based on the broadcast signal of the broadcast program, and the conversion data is used for generating the metadata representing the content of the broadcast program.

As described above, each television apparatus 20 can be responsible for processing a huge content, for example, unlike the case processing together with the server apparatus 10, thereby reducing the load on the server apparatus 10.

In addition, the above-described data conversion processing, for example, can be performed using the existing hardware structure of the television apparatus 20. There is no need to add a new structure to the television apparatus 20 or to reconstruct the television apparatus 20 itself, so that component costs and running costs can be suppressed.

The television apparatus 20 according to the embodiments transmits the conversion data to the server apparatus 10 that generates the metadata. By increasing the frequency of uploading to the server apparatus 10, the data processed by the server apparatus 10 is frequently updated. Therefore, for example, it is possible to cope with time-shift playback requiring a short processing time.

The television apparatus 20 according to the embodiments, convert the information of the broadcast program into the multi-dimensional array for each frame to generate the conversion data. As described above, by performing data conversion into the multi-dimensional array, huge data can be processed, and for example, by using the multi-dimensional array in the input and output data of the DNN, data analysis using the DNN technology becomes easier. Furthermore, the capacity of processing data in the server apparatus 10 can be reduced, and more information of contents can be collected and processed.

The television apparatus 20 according to the embodiments determines the task required for data conversion based on the program arrangement information, and allocates the determined task to the data processing component 23. Accordingly, for example, in data conversion processing that requires different tasks depending on the content or each frame of the broadcast program, an appropriate task can be allocated to the data processing component 23 and executed by it. In addition, the limited resources of the data processing component 23 can be effectively utilized.

The television apparatus 20 according to the embodiments, when there is a remaining resource in the data processing component 23, allocates the task that can be used for pre-processing of data conversion to the data processing component 23. As a result, the resources of the data processing component 23 can be effectively utilized.

The server apparatus 10 according to the embodiments generate the metadata based on the conversion data converted by the television apparatus 20.

This allows the server apparatus 10 to be responsible for generating metadata that requires processing of time sequence data, thereby preventing obstacles in the real-time processing of watching, recording, and playback of the television apparatus 20.

In addition, the server apparatus 10 only needs to execute the generation process of metadata that mainly processes time sequence data, and the load on the server apparatus 10 can also be reduced.

The server apparatus 10 according to the embodiments, when no information of the inference end position is included for more than the predetermined period elapsed from the inference start position of the advertisement based on the data processing component 23, determines that no advertisement is inserted at the inference start position. As described above, by performing the above determination in the server apparatus 10 capable of processing the time sequence data, the insertion position of the advertisement can be determined with high accuracy.

The server apparatus 10 according to the embodiments, when another inference start position or another inference end position is included between the inference start position and the inference end position of the advertisement, selects, from the combinations of these inference start positions and inference end positions, the combination which is most approximate to a multiple of the shortest broadcast time of the advertisement during the insertion period of the advertisement as the start position and end position of the advertisement. As described above, by performing the above determination in the server apparatus 10 capable of processing the time sequence data, the insertion position of the advertisement can be determined with high accuracy.

The server apparatus 10 according to the embodiments integrates the conversion data collected from at least the television apparatus 20, among the plurality of television apparatuses 20, that is providing the live broadcast of the broadcast program for watching into the time sequence data. As described above, by dispersing the data conversion processing in each of the plurality of television apparatuses 20, the load on the television apparatus 20 can be further reduced.

In addition, in the above-described embodiment, for example, the server apparatus 10 collects and integrates the conversion data from the plurality of television apparatuses 20 that are providing the live broadcast for watching, thereby generating the time sequence data. However, the service provider that generates the metadata may install a plurality of television apparatuses 20 in its own company or the like, and upload the conversion data from these television apparatuses 20 to the server apparatus 10.

In this case, real-time watching of the broadcast program of the specific broadcasting station can be always provided to each television apparatus 20 respectively. Thereby, the conversion data related to the broadcast program of one broadcasting station can be collected from one television apparatus 20, so that, for example, the processing of integrating the conversion data of a plurality of television apparatuses 20 is not required.

In addition, in the above embodiments, the receiving apparatus is the television apparatus 20, but the structure of the embodiments is not limited to this. For example, the receiving apparatus may be another apparatus such as a personal computer, a smartphone, a tablet, a mobile phone, or the like that has a broadcast signal reception function, a broadcast signal projection function, and a voice recognition service function.

Although the embodiments of the present application has been described, the embodiments are presented as examples and do not limit the scope of the present disclosure. The new embodiment can be implemented in various other forms, and various omissions, substitutions, and changes can be made without departing from the gist of the present disclosure. These embodiments and modifications thereof are included in the scope and spirit of the present disclosure, and are included in the present disclosure described in the claims and their equivalents.

What is claimed is:

1. A receiving apparatus, wherein: the receiving apparatus receives a broadcast program and provides the broadcast program which is available for being watched in a live broadcast manner; wherein
the receiving apparatus comprises:
a data processing component, during providing a live broadcast of the broadcast program for watching, configured to generate conversion data based on a broadcast signal of the broadcast program to enable generation of metadata representing a content of the broadcast program; and
a first transceiver component, configured to transmit the conversion data to a server apparatus that generates the metadata.

2. The receiving apparatus according to claim 1, wherein:
the data processing component is configured to convert the broadcast program into a multi-dimensional array for each frame to generate the conversion data.

3. The receiving apparatus according to claim 2, wherein:
the data processing component is configured to generate the conversion data based on the multi-dimensional array, wherein the conversion data comprises an estimation result obtained by estimating the content of the broadcast program.

4. The receiving apparatus according to claim 1, further comprising:
a broadcast receiving component, configured to receive the broadcast signal of the broadcast program and program arrangement information multiplexed in the broadcast signal; and
a task allocation component, configured to determine a task required for generating the conversion data based on the program arrangement information, and allocate the task determined to the data processing component.

5. The receiving apparatus according to claim 4, wherein:
after allocating the task to the data processing component, the task allocation component is configured to, based on that a remaining resource exists in the data processing component, allocate a pre-processing task for generating the conversion data to the data processing component.

6. A metadata generation system, comprising:
a receiving apparatus according to claim 1; and
a server apparatus, in communication with the receiving apparatus; wherein
the server apparatus comprises:
a second transceiver component, configured to receive the conversion data from the receiving apparatus; and
a metadata generation component, configured to generate the metadata based on the conversion data.

7. The metadata generation system according to claim 6, wherein:
the server apparatus further comprises an advertisement determination component, wherein the advertisement determination component is configured to determine an insertion position of an advertisement in the broadcast program; and
the metadata generation component is configured to generate the metadata comprising information representing the insertion position of the advertisement.

8. The metadata generation system according to claim 7, wherein:
the data processing component is configured to generate the conversion data for each frame, wherein the conversion data comprises information representing an inference start position and an inference end position of the advertisement; and
the advertisement determination component is configured to determine the insertion position of the advertisement based on time sequence data, wherein the time sequence data is time sequence data in which the conversion data of each frame is arranged in time sequence.

9. The metadata generation system according to claim 8, wherein:
the advertisement determination component is configured to determine that no advertisement is inserted at the inference start position when no information of the inference end position is comprised for more than a predetermined period elapsed from the inference start position.

10. The metadata generation system according to claim 8, wherein:
based on that another inference start position or another inference end position is comprised between the inference start position and the inference end position, the advertisement determination component is configured to select, from combinations of inference start positions and inference end positions, a combination which is most approximate to a multiple of a shortest broadcast time of the advertisement during an insertion period of the advertisement as a start position and an end position of the advertisement.

11. The metadata generation system according to claim 7, wherein:
the server apparatus is connected with a plurality of receiving apparatuses comprising the receiving apparatus in a communicable manner; and
the server apparatus further comprises an integration component, wherein the integration component is configured to integrate the conversion data collected from at least one of the plurality of receiving apparatuses that is providing a live broadcast of the broadcast program for watching into time sequence data.

12. The metadata generation system according to claim 11, wherein:
the server apparatus is configured to transmit the metadata to the first transceiver component of at least one of the plurality of receiving apparatuses, wherein the metadata is generated based on the conversion data.
